(19) United States
(12) Patent Application Publication
(10) Pub. No.: US 2006/0200402 A1
(43) Pub. Date: Sep. 7, 2006

(54) Internet based aggregation, interpretation, matching of disparate forms of bond holdings

(76) Inventors: Michael Neil Digris, New York City, NY (US); Edward Francis Healey, Winthrop, MA (US); Jeremy Andrew Roy, Boston, MA (US); Ryan Thomas Tremaine, Holliston, MA (US)

Correspondence Address: Michael N. Digris, #7B, 465 Columbus Avenue, New York City, NY, 10024, US

(21) Appl. No.: 11/071,953

(22) Filed: Mar. 4, 2005

(51) Int. Cl. G06Q 40/00

(52) U.S. Cl. 705/37

(57) ABSTRACT

A system is provided which enables the computer- and web-assisted assimilation of fixed income securities data. The system uses this data to identify potential trading opportunities. Semi-structured and unstructured data describing fixed income holdings, indications of interest and axes are automatically interpreted and assimilated into the system. Instances of similar data across different sets of data are automatically identified and subsequently notify individuals uniquely. Bids and offers are routed to the correct individuals after comparison with assimilated data.

### CROSS REFERENCE TO RELATED APPLICATIONS

N/A

### STATEMENT REGARDING FEDERAL SPONSORED R & D

N/A

### REFERENCE TO SEQUENCE LISTING, A TABLE OR A COMPUTER PROGRAM

N/A

### BACKGROUND OF INVENTION

Bond traders and sales people receive information from one another in the course of doing business. That information is a list of bonds that represents either a group of bonds owned by a financial institution or a list of bonds that a financial institution is interested in buying or selling. These lists of bonds exist in heterogeneous electronic formats and this creates a problem for bond traders and sales people when they need to find a bond that they are interested in, for whatever business reason they might have. Our invention aggregates and homogenizes the dissimilar lists of bonds, then matches indications of interests between owners of the bonds and those interested, routing notification to all relevant parties who are users of the system.

### BRIEF SUMMARY OF INVENTION

The present invention is directed to the problem of developing a method and system for aggregating lists of dissimilarly formatted bonds and then matching potential trading opportunities between users of the system based on those users' similarly held bonds or indications of interest initiated by a user of the system.

The present invention solves the problem of searching through lists of bonds, or what is otherwise referred to herein as sets of pricedata, that are not uniformly formatted. The system will normalize the pricedata so that descriptive characteristics of the bonds are homogenized across all pricedata and thus made searchable by users of the system.

The present invention solves these and other problems by providing a system and method for matching bonds that enables traders, or other users of the system, to enter axes or indications of interest through the system, thereby providing a salesperson or other user of the system with notification concerning their respective customers who hold bonds that the trader or other user of the system is interested in purchasing or selling.

These advantages, as well as others, will become readily apparent to those of ordinary skill in the art upon reading the Detailed Description and Claims herein.

### BRIEF DESCRIPTION OF THE DRAWINGS

N/A

### DETAILED DESCRIPTION

The processing described herein can be executed by a system running on a generic computer alone, or by using a specifically-designed computer. The processing can be executed by a standalone computer or on a set of computers working together.

Aggregation and Interpretation (Automatic Assimilation)

The system processes data that represents the ownership of fixed income securities (price data/bond holdings), as well as the desire to sell, to buy, or to swap sets of fixed income securities.

This “price data” is comprised of the issuers of debt, the coupon rate of a security, the maturity date, ratings information, prices and sizes, and many other descriptive and analytical data about fixed income securities.

This price data can be comprised of data of all possible fixed income security asset classes including but not limited to municipal bonds, corporate bonds, and mortgage-backed bonds. Price data represents many purposes including but not limited to a companies inventory of items to sell, a portfolio of items owned, a list of bids.

Price data describing the sales, trading and management of fixed income holdings is communicated among institutional investors in two distinct ways:

1) Data is described in documents of various formats including spreadsheets, Adobe PDF documents, and text files. For the purposes of describing the processing of this data, such documents are referred to as “semi-structured” data.

2) Data is described as typed by people in electronic mail of various types. Additionally this data can be copied and pasted from any number of sources. This data is “unstructured” and follows no preset order or format.

Semi- and unstructured data are transmitted via many forms of electronic communication including email, ftp, and web-based uploading.

The system analyzes the data and identifies all information automatically. For example, a column that says Size, or Amount, or Amt, or $, or 1000s, or any number of other labels is automatically identified as the size of a company's position in a particular bond. Once it has been identified, it is stored in a database where it can be used for matching and searching.

In the case of unstructured market data, the system is able to interpret and recognize information from email that is human typed, hand entered, and which follows no standard formatting at all. In this case the system employs an proprietary engine to analyze the data and store it.

The system allows the user to correct this automatic interpretation for both structured and unstructured data. The system learns from these corrections to improve future interpretations.

Matching and Routing

The vast majority of price data contains a unique Committee on Uniform Security Identification Procedures or CUSIP number.

The system can automatically identify, extract, and store this number. The system can then automatically run this number against other sets of price data in the system and notify individuals about any matching securities.

Routing of data occurs when in the course of business a user of the system wishes to inform other users about a live bid or offer. The system can automatically enhance this information with searches that happen automatically, in the background. These searches leverage the data from the assimilation of price data.

Recipients of the bid or offer (referred to as an “axe”) are presented with the bid or offer alongside the results of the searching for securities referred to in the axe in price data assigned to each person. Additionally, the user who generates the axe is sent a confirmation which shows the list of users notified along with relevant information from the price data.

1. An internet-based electronic interpretation and aggregation system (the system) for one or more of a myriad of debt instruments, including a myriad of bonds via a system comprised of one or more computers via which one or more bond sales people or traders uploads one or more forms of pricedata (the pricedata) including customer portfolios, bid lists, internal inventory or dealer inventory in spreadsheet or some other column and row or list based format. The system interprets and aggregates (homogenizes and normalizes) disparate column headings within the pricedata. These column headings include any abbreviations, pseudonyms or acronyms representing the full title of the column heading as well as the full title. The aggregation and interpretation makes the pricedata searchable via the system by bond sales people or traders.

2. An internet-based electronic interpretation and aggregation system (the system) for one or more of a myriad of debt instruments, including a myriad of bonds via a system comprised of one or more computers via which one or more bond sales people or traders uploads one or more forms of pricedata (the pricedata) including customer portfolios, bid lists, internal inventory or dealer inventory in email, as both hand-entered by a human being, or put forth in an arbitrary format by some other system.

3. The system according to claim 1, further comprising: a database coupled to the aggregation and interpretation engine and storing all aggregated and interpreted pricedata for each of the system users.

3. The system according to claim 1, wherein said system displays results of executed searches on aggregated and interpreted pricedata via an internet browser.

4. The system according to claim 1, further comprising an internal computer network LAN (Local Area Network).

5. The system according to claim 4, wherein the computer network includes the Internet or a WAN (Wide Area Network).

6. The system according to claim 1, where said system creates an audit trail for each search or set or pricedata entered into the system.

7. The system according to claim 6, where said audit trail includes a record of every database modification that occurs in the system.

8. The system according to claim 7, where said record of every database modification includes tracing each data point that was changed, when each data point was changed and the value of the data point before and after the change.

9. A computer-based method implemented in the system for matching one or more debt instruments, including one or more bonds, from within one set of aggregated and interpreted pricedata to one or more similar or identical debt instruments, including one or more similar or identical bonds, within another set of pricedata within the system. The matching instances are then reported and notifications of the matching instances are then routed to all owners or representatives of matching debt instruments, including bonds. Matching instances are generated based on a pricedata search initiated by a user of the system or an indication of interest in buying or selling one or more debt instruments, including one or more bonds, (an axe) entered into the system by user.

11. A computer-based method implemented in the system for routing axes and indications of interest one or more debt instruments, including one or more bonds, to one or more similar or identical debt instruments, including one or more similar or identical bonds, within another set of pricedata within the system, and routing the axe along with the matching bonds to the correct owners of matching debt instruments including bonds.

12. A computer-based method implemented in the system for comparing two sets of data from the same institution or company, as interpreted by the system, in order to determine the additions, subtractions, buys, sells, instruments which matured, of debt instruments including bonds held by the institution or company, between the dates when each set of the data was created.
